(19) United States
(12) Patent Application Publication
(10) Pub. No.: US 2026/0119725 A1
(43) Pub. Date: Apr. 30, 2026

(54) SECURE ENVIRONMENT VERIFICATION METHODS AND APPARATUSES

(71) Applicant: Alipay (Hangzhou) Digital Service Technology Co., Ltd., Hangzhou (CN)

(72) Inventors: Wuqiong PAN, Hangzhou, Zhejiang (CN); Chan Zhao, Hangzhou (CN); Tao Wei, Hangzhou (CN); Yuduo Wu, Hangzhou (CN); Tingting Li, Hangzhou (CN); Chen Qian, Hangzhou (CN)

(21) Appl. No.: 19/431,400

(22) Filed: Dec. 23, 2025

Related U.S. Application Data
(63) Continuation of application No. PCT/CN2024/111803, filed on Aug. 13, 2024.

(30) Foreign Application Priority Data
Sep. 5, 2023 (CN) 202311144515.4

(51) Int. Cl. G06F 21/88; H04L 9/32

(52) U.S. Cl. CPC G06F 21/88; H04L 9/3247

(57) ABSTRACT

A secure environment verification method is applied to a trusted execution environment (TEE), a device in which the TEE is located is provided with a physical peripheral configured to protect the device, and the physical peripheral includes anti-theft hardware. The method includes: generating a random number when a specified moment arrives; sending the random number to the anti-theft hardware, wherein the anti-theft hardware signs the random number based on a private key of the anti-theft hardware; receiving a signature result returned by the anti-theft hardware; determining, based on a pre-established binding relationship, a public key bound to the TEE; performing signature verification on the signature result based on the public key, and verifying, based on a signature verification result, whether the physical peripheral is normal; and sending a verification result to a user.

### CROSS-REFERENCE TO RELATED APPLICATIONS

This application is a continuation application of International Application No. PCT/CN2024/111803, filed Aug. 13, 2024, which claims priority to Chinese Patent Application No. 202311144515.4, filed on Sep. 5, 2023, the entire contents of both of which are incorporated herein by reference.

### TECHNICAL FIELD

This specification relates to the computer field, and in particular, to secure environment verification methods and apparatuses, storage media, and electronic devices.

### BACKGROUND

With development of Internet technologies, an amount of data used to execute a user task increases accordingly. Due to different requirements of users, data of several data parties may need to be used for calculation, to complete services requested by the users. For data security, the data of the several data parties can be transmitted to the same secure environment for calculation, and the secure environment can be established in any one of the several data parties. The secure environment is a trusted execution environment (TEE) constructed in a device of the any data party based on a trustzone technology.

To protect the TEE, a device in which the TEE is located is usually provided with a physical peripheral. However, if a data party in which the TEE is established is a malicious data party, the data party in which the TEE is established may not be provided with a physical peripheral for protecting the TEE, and even attacks a TEE with a physical peripheral, to steal data of another data party. Because communication is not established between the TEE and the physical peripheral, the another data party cannot learn of whether the data party is provided with the physical peripheral for protecting the TEE and whether the physical peripheral runs normally.

### SUMMARY

A first aspect of this specification provides a secure environment verification method. The method is applied to a trusted execution environment (TEE), a device in which the TEE is located is provided with a physical peripheral, the physical peripheral is configured to protect the device, the physical peripheral includes anti-theft hardware, and the method includes: generating a random number when a specified moment arrives; sending the random number to the anti-theft hardware, so that the anti-theft hardware signs the random number based on a private key of the anti-theft hardware; receiving a signature result returned by the anti-theft hardware; determining, based on a pre-established binding relationship, a public key bound to the TEE; performing signature verification on the signature result based on the public key; verifying, based on a signature verification result, whether the physical peripheral is normal, where the verifying includes: if the signature verification succeeds, determining that the physical peripheral is normal; or if the signature verification fails, determining that the physical peripheral is abnormal; and sending a verification result to a user.

A second aspect of this specification provides a secure environment verification method. The method is applied to anti-theft hardware, the anti-theft hardware is a part of a physical peripheral, the physical peripheral is configured to protect a device, the device includes a trusted execution environment (TEE), and the method includes: receiving a random number sent by the TEE; signing the random number based on a private key of the anti-theft hardware, to obtain a signature result; and returning the signature result to the TEE, so that the TEE performs signature verification on the signature result; verifies, based on a signature verification result, whether the physical peripheral is normal; and sends a verification result to a user.

A third aspect of this specification provides a secure environment verification apparatus. The apparatus is applied to a trusted execution environment (TEE), a device in which the TEE is located is provided with a physical peripheral, the physical peripheral is configured to protect the device, the physical peripheral includes anti-theft hardware, and the apparatus includes: a processor, and a memory storing instructions executable by the processor. The processor is configured to: generate a random number when a specified moment arrives; send the random number to the anti-theft hardware, so that the anti-theft hardware signs the random number based on a private key of the anti-theft hardware; receive a signature result returned by the anti-theft hardware; determine, based on a pre-established binding relationship, a public key bound to the TEE; perform signature verification on the signature result based on the public key; verify, based on a signature verification result, whether the physical peripheral is normal, where the verifying includes: if the signature verification succeeds, determine that the physical peripheral is normal; or if the signature verification fails, determine that the physical peripheral is abnormal; and send a verification result to a user.

A fourth aspect of this specification provides a secure environment verification apparatus. The apparatus is applied to anti-theft hardware, the anti-theft hardware is a part of a physical peripheral configured to protect a device, the device includes a trusted execution environment (TEE), and the apparatus includes: a processor, and a memory storing instructions executable by the processor. The processor is configured to receive a random number sent by the TEE; sign the random number based on a private key of the anti-theft hardware, to obtain a signature result; and return the signature result to the TEE, so that the TEE performs signature verification on the signature result; verifies, based on a signature verification result, whether the physical peripheral is normal; and sends a verification result to a user.

### BRIEF DESCRIPTION OF DRAWINGS

The accompanying drawings described herein are used to provide a further understanding of this specification and constitute a part of this specification. The example embodiments of this specification and descriptions thereof are used to explain this specification, and do not constitute an improper limitation on this specification.

FIG. 1 is a flowchart illustrating a secure environment verification method, according to an embodiment.

FIG. 2 is a schematic diagram illustrating interaction between a TEE and anti-theft hardware, according to an embodiment.

FIG. 3 is a schematic diagram illustrating a secure environment verification apparatus, according to an embodiment.

FIG. 4 is a schematic diagram illustrating an electronic device, according to an embodiment.

### DETAILED DESCRIPTION OF EMBODIMENTS

The following describes example embodiments of this specification with reference to the accompanying drawings. Clearly, the described embodiments are merely some but not all of embodiments of this specification. All other embodiments obtained by a person of ordinary skill in the art based on the embodiments of this specification without creative efforts shall fall within the protection scope of this application.

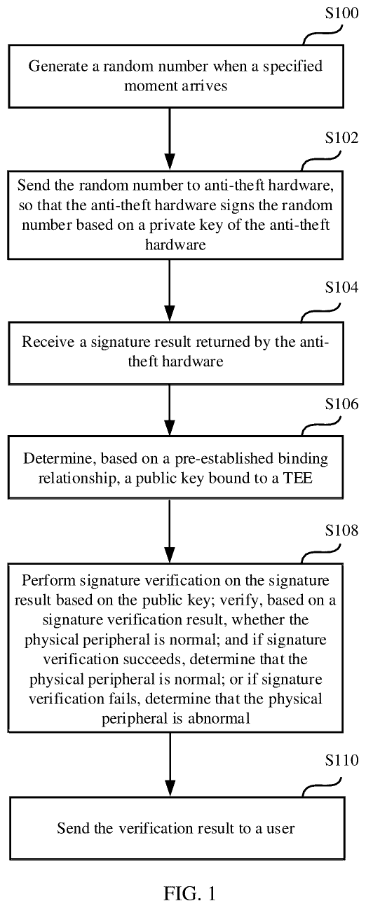

FIG. 1 is a flowchart illustrating a secure environment verification method, according to an embodiment. The method includes the following steps.

S100: Generate a random number when a specified moment arrives.

When a to-be-executed service needs data of a plurality of data parties, the data of the plurality of data parties is usually transmitted to the same secure environment for calculation. The secure environment can be a trusted execution environment (TEE) established by any data party on a device in which the data party is located. In addition, to protect the TEE, the data party in which the TEE is established can be further provided with a physical peripheral. However, if the data party in which the TEE is established is an intrusion party, that is, to obtain data of another data party in the TEE, the data party in which the TEE is established is not provided with a physical peripheral, or even attacks the TEE with a physical peripheral. If communication is not established between the TEE and the physical peripheral, the another data party cannot learn of whether the intrusion party is provided with a physical peripheral for protecting the TEE and whether the physical peripheral runs normally. Therefore, this specification provides a secure environment verification method. In the embodiment, an execution body can be a TEE, or can be a part of a physical peripheral that establishes communication with the secure environment, for example, anti-theft hardware of the physical peripheral, or can be a server in which another secure environment in which the data of the another data party can be securely calculated is located. This specification sets no limitation thereto. This specification is described by using an example in which the TEE and the anti-theft hardware are execution bodies.

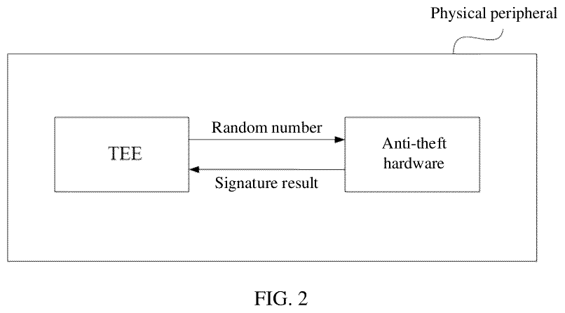

FIG. 2 is a schematic diagram illustrating interaction between a TEE and anti-theft hardware, according to an embodiment.

In one or more embodiments of this specification, a device in which the TEE is located is provided with a physical peripheral, and the physical peripheral is used to protect the device. The physical peripheral can include a housing, which is used to prevent against opening, from the outside, the device in which the TEE is located; a detection component used to detect whether a physical intrusion occurs on the device; a heat dissipation channel used for heat dissipation; and anti-theft hardware used to communicate with the TEE. The physical intrusion includes disassembling the device by using an external force, for example, destroying the housing of the physical peripheral by using an electric drill, or melting the housing of the physical peripheral by using an electric heating apparatus. Therefore, the detection component can be a switch detection apparatus. For example, a push-button switch is disposed inside the housing of the physical peripheral. When the housing is not opened, the switch is in a pressed state, and the switch is opened. When the housing is opened, the switch is closed, and it is considered that a physical invasion occurs. The detection component can further be a temperature detection apparatus. When the electric heating apparatus is used, a temperature of the housing increases; and when the temperature detection apparatus detects that the temperature of the housing exceeds a threshold, it is considered that a physical invasion occurs. This specification does not limit a type of the detection component, provided that the detection component can detect that a physical invasion occurs on the physical peripheral. If the detection component detects that a physical invasion occurs on the physical peripheral, a detection result is sent to the anti-theft hardware, so that the anti-theft hardware determines whether a physical invasion occurs on the physical peripheral. The anti-theft hardware includes an anti-theft chip. It should be noted that the heat dissipation channel also needs to have a feature of being unable to be invaded. That is, the intrusion party cannot steal data in the TEE through the heat dissipation channel. The intrusion party includes any data party that obtains, from the TEE without permission of another data party, data that is not data of the intrusion party.

To detect whether the physical peripheral runs normally, when a specified moment arrives, the TEE generates a random number, to subsequently verify, based on the random number, whether the physical peripheral runs normally. The specified moment can be a moment at which the TEE responds to a security verification request of a user for querying whether the physical peripheral runs normally, or can be a moment at which a preset period of the TEE ends. This is not limited in this specification. It should be noted that the user in a specific implementation of this specification is a data party that does not establish the TEE and that transmits data to the TEE.

S102: Send the random number to anti-theft hardware, so that the anti-theft hardware signs the random number based on a private key of the anti-theft hardware.

Because the TEE can determine, based on a public key and a private key, whether the physical peripheral device runs normally, the TEE can send the random number to the anti-theft hardware of the physical peripheral; and the anti-theft hardware receives the random number sent by the TEE, signs the random number based on the private key of the anti-theft hardware, to obtain a signature result, and then returns the signature result to the TEE, so that the TEE performs signature verification on the signature result based on the public key, to determine whether the physical peripheral runs normally.

S104: Receive the signature result returned by the anti-theft hardware.

S106: Determine, based on a pre-established binding relationship, a public key bound to the TEE.

There may be a plurality of TEEs in one server. For each TEE, the TEE can determine, based on the public key and the private key, whether the physical peripheral runs normally. Therefore, there may be several public keys in one server. To help the TEE to subsequently perform signature verification based on the public key, the binding relationship between the TEE and the public key is pre-established.

For example, the TEE receives the public key sent by the anti-theft hardware, establishes the binding relationship between the public key and the TEE, and stores the public key. Because the public key is obtained based on the private key, if the public key is a public key provided by the intrusion party, the intrusion party can tamper with a running state of the physical peripheral based on the public key and a private key that are provided by the intrusion party to the TEE. Therefore, the public key bound to the TEE can be generated based on the private key of the anti-theft hardware. How to bind the public key and the TEE is not limited in this specification, provided that the public key can be bound to the TEE.

In addition, the private key used when the anti-theft hardware performs a signing operation is a private key corresponding to the public key bound to the TEE. Therefore, before performing signature verification based on the public key, the TEE needs to determine, based on the pre-established binding relationship, the public key bound to the TEE. That is, if the public key for performing signature verification on the signature result is not the public key bound to the TEE, signature verification may fail even if the signature result is obtained based on the private key corresponding to the public key bound to the TEE. Then, the user may obtain an incorrect state of the physical peripheral.

For example, there are two TEEs currently: a TEE 1 and a TEE 2, two pairs of public and private keys: a public key 1, a private key 1, a public key 2, and a private key 2, the private key 1 corresponds to the public key 1, the private key 2 corresponds to the public key 2, the TEE 1 is bound to the public key 1, and the TEE 2 is bound to the public key 1. The TEE 1 needs to determine the state of the physical peripheral. The anti-theft hardware sends a signature result obtained based on the private key 1 to the TEE 1. The TEE 1 does not determine the public key 1 based on the binding relationship, and directly verifies the signature result based on the public key 2, to obtain an error result that the physical peripheral runs abnormally.

S108: Perform signature verification on the signature result based on the public key; verify, based on a signature verification result, whether the physical peripheral is normal; and if signature verification succeeds, determine that the physical peripheral is normal; or if signature verification fails, determine that the physical peripheral is abnormal.

In one or more embodiments, if the signature result is not obtained based on the private key corresponding to the public key bound to the TEE, verification fails, and the physical peripheral is abnormal. On the contrary, the physical peripheral is normal.

S110: Send a verification result to the user.

According to the secure environment verification method shown in FIG. 1, communication between the TEE and the anti-theft hardware is directly established. The TEE verifies, based on the signature result sent by the anti-theft hardware, whether the physical peripheral runs normally, and sends the verification result to the user, that is, sends the verification result to another data party in which the TEE is not established. The user obtains a state of the physical peripheral by using the TEE, that is, the user learns of, by using the TEE, whether a data party in which the TEE is established is provided with a physical peripheral for protecting the TEE and whether the physical peripheral runs. In addition, because the TEE directly communicates with the anti-theft hardware, the state of the physical peripheral does not need to be learned of through another medium. Therefore, the obtained state of the physical peripheral is not tampered with by the data party in which the TEE is established.

For steps S102 to S108, the TEE can further determine, based on a symmetric cryptographic algorithm, whether the physical peripheral runs normally. In this case, when the binding relationship is established, the TEE receives a key sent by the anti-theft hardware, and establishes and stores the binding relationship between the public key and the TEE. When the signature result is obtained, the anti-theft hardware signs the random number based on the key of the anti-theft hardware. When verifying the signature result, the TEE performs signature verification on the signature result based on a key bound to the TEE.

For step S106, to reduce resource consumption, when a plurality of TEEs in a server need to simultaneously determine whether the physical peripheral device is normal, a random number generated by each TEE is hashed, to obtain a hash value; the hash value is sent to the anti-theft hardware; and the anti-theft hardware signs the hash value based on the private key, to obtain a signature result, and returns the signature result and the hash value to each TEE. Each TEE performs signature verification on the signature result based on a public key bound to the TEE, and determines, based on the hash value, whether the random number generated by each TEE can be obtained. Then, the anti-theft hardware can respond, by performing signing only one time, to a request of the plurality of TEEs for determining whether the physical peripheral is normal.

For step S108, to protect the data in the TEE, when signature verification performed by the TEE fails and it is determined that the physical peripheral is abnormal, a service provided by the TEE is disabled, and/or current data is cleared. If only the service provided by the TEE is disabled, a waste of computing resources can be reduced. If only the current data is cleared, the intrusion party cannot obtain data that can be used to perform subsequent steps and the current data, to reduce a data loss.

In addition to verifying the signature result by the TEE, the anti-theft hardware can be used to determine whether the physical peripheral is normal, to determine whether to disable the service provided by the TEE and/or clear the current data. That is, the anti-theft hardware determines whether a physical invasion occurs on the physical peripheral. If yes, the anti-theft hardware sends a disabling request to the TEE. In response to the disabling request sent by the anti-theft hardware, the TEE disables the service provided by the TEE and/or clears the current data. The anti-theft hardware can determine, by using the detection component of the physical peripheral, whether a physical invasion occurs on the physical peripheral.

To further protect the data in the TEE, the TEE can encrypt the stored data, to prevent the intrusion party from obtaining data that has been stored in a disk.

For example, the public key bound to the TEE is used to encrypt the data stored in the TEE. When the anti-theft hardware determines that a physical invasion occurs on the physical peripheral, the private key corresponding to the public key bound to the TEE is cleared, and the intrusion party cannot obtain the data stored in the disk. In addition, because the private key is cleared, the TEE can verify, based on the public key, that the signature result is incorrect; determine that the physical peripheral runs abnormally; and then disable the service provided by the TEE and/or clear the current data, to protect the data in the TEE. Certainly, before the data stored in the TEE is encrypted based on the public key bound to the TEE, the stored data can be encrypted based on a TEE seal mechanism existing in the TEE. This is not limited in this specification.

In addition, communication between the TEE and a trusted platform module (TPM) can be established. Because the TPM has a function of determining whether the verification result sent to the user is tampered with, the TEE can enable the user to obtain a correct verification result by using the TPM.

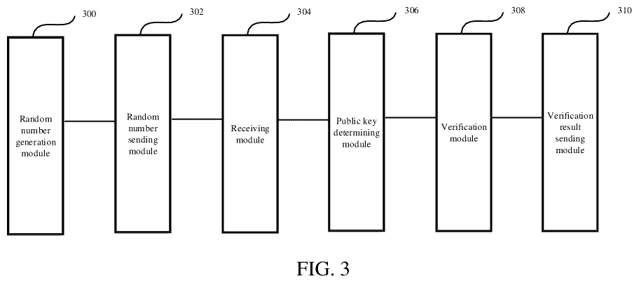

FIG. 3 is a schematic diagram illustrating a secure environment verification apparatus, according to an embodiment. The apparatus is applied to a trusted execution environment (TEE), a device in which the TEE is located is provided with a physical peripheral, the physical peripheral is configured to protect the device, the physical peripheral includes anti-theft hardware, and the apparatus includes: a random number generation module 300, configured to generate a random number when a specified moment arrives; a random number sending module 302, configured to send the random number to the anti-theft hardware, so that the anti-theft hardware signs the random number based on a private key of the anti-theft hardware; a receiving module 304, configured to receive a signature result returned by the anti-theft hardware; a public key determining module 306, configured to determine, based on a pre-established binding relationship, a public key bound to the TEE; a verification module 308, configured to: perform signature verification on the signature result based on the public key; verify, based on a signature verification result, whether the physical peripheral is normal; and if signature verification succeeds, determine that the physical peripheral is normal; or if signature verification fails, determine that the physical peripheral is abnormal; and a verification result sending module 310, configured to send the verification result to a user.

In an embodiment, the representative public key determining module 306 is further configured to: receive a public key sent by the anti-theft hardware; and establish and store a binding relationship between the public key and the TEE.

In an embodiment, the apparatus further includes: a first interrupt module configured to: when signature verification performed by the TEE fails and it is determined that the physical peripheral is abnormal, disable a service provided by the TEE, and/or clear current data.

In an embodiment, the apparatus further includes: a second interrupt module configured to: in response to a disabling request sent by the anti-theft hardware, disable a service provided by the TEE, and/or clear current data, where the disabling request is sent to the TEE when the anti-theft hardware determines that a physical invasion occurs on the physical peripheral.

In an embodiment, the apparatus further includes: an encryption module configured to encrypt, based on the public key, data stored in the TEE.

Embodiments of this specification also provide a secure environment verification apparatus applied to anti-theft hardware. The anti-theft hardware is a part of a physical peripheral configured to protect a device, and the device includes a trusted execution environment (TEE). The apparatus includes: a random number receiving module configured to receive a random number sent by the TEE; a signing module configured to sign the random number based on a private key of the anti-theft hardware, to obtain a signature result; and a signature result returning module configured to return the signature result to the TEE, so that the TEE performs signature verification on the signature result; verifies, based on the signature verification result, whether the physical peripheral is normal; and sends the signature verification result to a user.

In an embodiment, the apparatus further includes: a first determining module configured to: determine whether a physical invasion occurs on the physical peripheral; and if yes, clear the private key.

In an embodiment, the apparatus further includes: a second determining module configured to: determine whether a physical invasion occurs on the physical peripheral; and if yes, send a disabling request to the TEE.

Embodiments of this specification further provide a non-transitory computer-readable storage medium storing a computer program that, when executed by a processor, caused the processor to perform the above secure environment verification method.

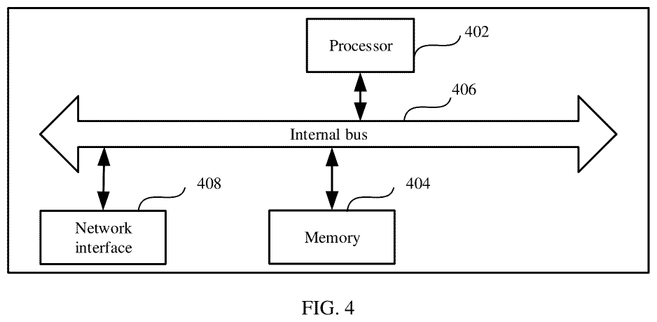

FIG. 4 is a schematic diagram illustrating an electronic device, according to an embodiment. For example, the electronic device is a secure environment verification apparatus. As shown in FIG. 4, the electronic device includes a processor 402 and a memory 404 storing instructions executable by the processor 402, and can also include an internal bus 406, a network interface 408, or hardware needed. For example, the processor 402 reads a corresponding computer program from the memory 404 and executes the computer program to perform the above secure environment verification method. The electronic device can also include, for example, a logic device.

In some embodiments, the secure environment verification method can be implemented with a programmable logic device (PLD) (for example, a field programmable gate array (FPGA)), and a logical function of the PLD is determined by a user through device programming. In addition, the secure environment verification method can be implemented with “logic compiler” software. The “logic compiler” software is similar to a software compiler used to develop and write a program. Original code needs to be written in a particular programming language before being compiled. The language is referred to as a hardware description language (HDL). There are many HDLs such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). Currently, the Very-High-Speed Integrated Circuit Hardware Description Language (VHDL) and Verilog are most commonly used.

In some embodiments, the secure environment verification method can be implemented with a controller. For example, the controller can be in a form of a microprocessor or a processor, a computer-readable medium that stores computer-readable program code (such as software or firmware) that can be executed by the microprocessor or the processor, a logic gate, a switch, an application-specific integrated circuit (ASIC), a programmable logic controller, or an embedded microcontroller. A memory controller can also be implemented as a part of control logic of a memory. A person skilled in the art also knows that in addition to implementing the controller by using only the computer-readable program code, logic programming can be performed on method steps to enable the controller to implement the same function in a form of a logic gate, a switch, an application-specific integrated circuit, a programmable logic controller, an embedded microcontroller, etc.

Systems, apparatuses, modules, or units that are set forth in the previous implementations can be embodied by a computer chip or an entity with a specific function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above apparatus is divided into modules based on functions for separate description. Each module can be implemented in one or more pieces of software and/or hardware.

It should be understood that computer program instructions may be used to implement each process and/or each block in the flowcharts and/or the block diagrams and a combination of a process and/or a block in the flowcharts and/or the block diagrams. These computer program instructions can be provided for a general-purpose computer, a special-purpose computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

These computer program instructions can alternatively be stored in a computer-readable memory that can instruct the computer or another programmable data processing device to work in a specific way, so the instructions stored in the computer-readable memory generate an instruction apparatus. The instruction apparatus implements a specific function in one or more procedures in the flowcharts and/or in one or more blocks in the block diagrams.

These computer program instructions can alternatively be loaded onto the computer or another programmable data processing device, so that a series of operation steps are performed on the computer or the another programmable device, thereby generating computer-implemented processing. Therefore, the instructions executed on the computer or the another programmable device provide steps for implementing a specific function in one or more procedures in the flowcharts and/or in one or more blocks in the block diagrams.

The memory of the electronic device can include a non-persistent memory, a random access memory (RAM), a nonvolatile memory, and/or another form in a computer-readable medium, for example, a read-only memory (ROM) or a flash random access memory (flash RAM). The memory is an example of the computer-readable medium.

Examples of the computer storage medium include but are not limited to a phase-change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage or another magnetic storage device, or any other non-transmission medium. The computer storage medium can be configured to store information accessible to a computing device. As described in this specification, the computer-readable medium does not include computer-readable transitory media such as a modulated data signal and a carrier.

It should also be noted that the term “include”, “comprise” or any other variant thereof is intended to cover non-exclusive inclusion, so that a process, method, or device that includes a series of elements includes not only those elements but also other elements that are not explicitly listed, or includes elements inherent in such a process, method, or device. Without more constraints, an element preceded by “includes a . . . ” does not preclude the existence of additional identical elements in the process, method, or device that includes the element.

In some embodiments, the secure environment verification method can be implemented with a program module. Generally, the program module includes a routine, a program, an object, a component, a data structure, etc. executing a specific task or implementing a specific abstract data type. The secure environment verification method can be implemented in distributed computing environments. In the distributed computing environments, tasks are performed by remote processing devices connected through a communication network. In a distributed computing environment, the program module can be located in both local and remote computer storage media including storage devices.

The embodiments of this specification are described in a progressive method. For same or similar parts in the embodiments, references can be made to each other.

Embodiments of this specification provide a secure environment verification method applied to a trusted execution environment (TEE). A device in which the TEE is located is provided with a physical peripheral configured to protect the device, and the physical peripheral includes anti-theft hardware. The method includes: generating a random number when a specified moment arrives; sending the random number to the anti-theft hardware, so that the anti-theft hardware signs the random number based on a private key of the anti-theft hardware; receiving a signature result returned by the anti-theft hardware; determining, based on a pre-established binding relationship, a public key bound to the TEE; performing signature verification on the signature result based on the public key; verifying, based on a signature verification result, whether the physical peripheral is normal; and if the signature verification succeeds, determining that the physical peripheral is normal; or if the signature verification fails, determining that the physical peripheral is abnormal; and sending a verification result to a user.

In an embodiment, pre-establishing the binding relationship includes: receiving a public key sent by the anti-theft hardware; and establishing and storing a binding relationship between the public key and the TEE.

In an embodiment, when signature verification performed by the TEE fails and it is determined that the physical peripheral is abnormal, the method further includes: disabling a service provided by the TEE, and/or clearing current data.

In an embodiment, the method further includes: in response to a disabling request sent by the anti-theft hardware, disabling a service provided by the TEE, and/or clearing current data, where the disabling request is sent to the TEE when the anti-theft hardware determines that a physical invasion occurs on the physical peripheral.

In an embodiment, the method further includes: encrypting, based on the public key, data stored in the TEE.

Embodiments of this specification also provide a secure environment verification method applied to anti-theft hardware. The anti-theft hardware is a part of a physical peripheral configured to protect a device, and the device includes a trusted execution environment (TEE). The method includes: receiving a random number sent by the TEE; signing the random number based on a private key of the anti-theft hardware, to obtain a signature result; and returning the signature result to the TEE, so that the TEE performs signature verification on the signature result; verifies, based on a signature verification result, whether the physical peripheral is normal; and sends a verification result to a user.

In an embodiment, the method further includes: determining whether a physical invasion occurs on the physical peripheral; and if yes, clearing the private key.

In an embodiment, the method further includes: determining whether a physical invasion occurs on the physical peripheral; and if yes, sending a disabling request to the TEE.

Embodiments of this specification also provide a secure environment verification apparatus applied to a trusted execution environment (TEE). A device in which the TEE is located is provided with a physical peripheral configured to protect the device, and the physical peripheral includes anti-theft hardware. The apparatus includes: a random number generation module, configured to generate a random number when a specified moment arrives; a random number sending module, configured to send the random number to the anti-theft hardware, so that the anti-theft hardware signs the random number based on a private key of the anti-theft hardware; a receiving module, configured to receive a signature result returned by the anti-theft hardware; a public key determining module, configured to determine, based on a pre-established binding relationship, a public key bound to the TEE; a verification module, configured to: perform signature verification on the signature result based on the public key; verify, based on a signature verification result, whether the physical peripheral is normal; and if the signature verification succeeds, determine that the physical peripheral is normal; or if the signature verification fails, determine that the physical peripheral is abnormal; and a verification result sending module, configured to send a verification result to a user.

In an embodiment, the public key determining module is configured to: receive a public key sent by the anti-theft hardware; and establish and store a binding relationship between the public key and the TEE.

In an embodiment, the apparatus further includes: a first interrupt module configured to: when the signature verification fails and it is determined that the physical peripheral is abnormal, disable a service provided by the TEE, and/or clear current data.

In an embodiment, the apparatus further includes: a second interrupt module configured to: in response to a disabling request sent by the anti-theft hardware, disable a service provided by the TEE, and/or clear current data, where the disabling request is sent to the TEE when the anti-theft hardware determines that a physical invasion occurs on the physical peripheral.

In an embodiment, the apparatus further includes: an encryption module configured to encrypt, based on the public key, data stored in the TEE.

Embodiments of this specification also provide a secure environment verification apparatus applied to anti-theft hardware. The anti-theft hardware is a part of a physical peripheral configured to protect a device, and the device includes a trusted execution environment (TEE). The apparatus includes: a random number receiving module, configured to receive a random number sent by the TEE; a signing module, configured to sign the random number based on a private key of the anti-theft hardware, to obtain a signature result; and a signature result returning module, configured to return the signature result to the TEE, so that the TEE performs signature verification on the signature result; verifies, based on a signature verification result, whether the physical peripheral is normal; and sends a verification result to a user.

In an embodiment, the apparatus further includes: a first determining module configured to: determine whether a physical invasion occurs on the physical peripheral; and if yes, clear the private key.

In an embodiment, the apparatus further includes: a second determining module configured to: determine whether a physical invasion occurs on the physical peripheral; and if yes, send a disabling request to the TEE.

Embodiments of this specification also provide a non-transitory computer-readable storage medium storing a computer program that, when executed by a processor, causes the processor to perform the above secure environment verification method.

Embodiments of this specification also provide a secure environment verification apparatus, including a processor, and a memory storing a computer program executable by the processor, where the processor is configured to perform the above secure environment verification method.

Embodiments of this specification can achieve the following beneficial effects. In the secure environment verification method provided in this specification, communication between the TEE and the anti-theft hardware is directly established. The TEE verifies, based on the signature result sent by the anti-theft hardware, whether the physical peripheral runs normally, and sends the verification result to the user, that is, sends the verification result to another data party in which the TEE is not established. The user obtains a state of the physical peripheral by using the TEE, that is, the user learns of, by using the TEE, whether a data party in which the TEE is established is provided with a physical peripheral for protecting the TEE and whether the physical peripheral runs. In addition, because the TEE directly communicates with the anti-theft hardware, the state of the physical peripheral does not need to be learned of through another medium. Therefore, the obtained state of the physical peripheral is not tampered with by the data party in which the TEE is established.

The above descriptions are merely example embodiments of this specification, and are not intended to limit this specification. A person skilled in the art can make various modifications and changes to this specification. Any modification, equivalent replacement, or improvement made in the spirit and principles of this specification shall be included in the scope of the claims.

1. A secure environment verification method, wherein the method is applied to a trusted execution environment (TEE), a device in which the TEE is located is provided with a physical peripheral configured to protect the device, the physical peripheral comprises anti-theft hardware, and the method comprises:
generating a random number when a specified moment arrives;
sending the random number to the anti-theft hardware, wherein the anti-theft hardware signs the random number based on a private key of the anti-theft hardware;
receiving a signature result returned by the anti-theft hardware;
determining, based on a pre-established binding relationship, a public key bound to the TEE;
performing signature verification on the signature result based on the public key, and verifying, based on a signature verification result, whether the physical peripheral is normal, wherein the verifying comprises: if the signature verification succeeds, determining that the physical peripheral is normal; or if the signature verification fails, determining that the physical peripheral is abnormal; and
sending a verification result to a user.

2. The method according to claim 1, wherein pre-establishing the binding relationship comprises:
receiving a public key sent by the anti-theft hardware; and
establishing and storing the binding relationship between the public key and the TEE.

3. The method according to claim 1, wherein the signature verification fails and it is determined that the physical peripheral is abnormal, the method further comprising at least one of:
disabling a service provided by the TEE; or
clearing current data.

4. The method according to claim 1, further comprising at least one of:
disabling a service provided by the TEE or clearing current data, in response to a disabling request sent by the anti-theft hardware, wherein the disabling request is sent to the TEE when the anti-theft hardware determines that a physical invasion occurs on the physical peripheral.

5. The method according to claim 1, further comprising:
encrypting, based on the public key, data stored in the TEE.

6. A data protection method, wherein the method is applied to anti-theft hardware, the anti-theft hardware is a part of a physical peripheral configured to protect a device, the device comprises a trusted execution environment (TEE), and the method comprises:
receiving a random number sent by the TEE;
signing the random number based on a private key of the anti-theft hardware, to obtain a signature result; and
returning the signature result to the TEE, wherein the TEE performs signature verification on the signature result; verifies, based on a signature verification result, whether the physical peripheral is normal; and sends a verification result to a user.

7. The method according to claim 6, further comprising:
determining whether a physical invasion occurs on the physical peripheral; and
if it is determined that the physical invasion occurs on the physical peripheral, clearing the private key.

8. The method according to claim 6, further comprising:
determining whether a physical invasion occurs on the physical peripheral; and
if it is determined that the physical invasion occurs on the physical peripheral, sending a disabling request to the TEE.

9. A secure environment verification apparatus, wherein the apparatus is applied to a trusted execution environment (TEE), a device in which the TEE is located is provided with a physical peripheral configured to protect the device, the physical peripheral comprises anti-theft hardware, and the apparatus comprises:
a processor; and
a memory storing instructions executable by the processor,
wherein the processor is configured to:
generate a random number when a specified moment arrives;
send the random number to the anti-theft hardware, wherein the anti-theft hardware signs the random number based on a private key of the anti-theft hardware;
receive a signature result returned by the anti-theft hardware;
determine, based on a pre-established binding relationship, a public key bound to the TEE;
perform signature verification on the signature result based on the public key, and verify, based on a signature verification result, whether the physical peripheral is normal, wherein verifying whether the physical peripheral is normal comprises: if the signature verification succeeds, determining that the physical peripheral is normal; or if the signature verification fails, determining that the physical peripheral is abnormal; and
send a verification result to a user.

10. The apparatus according to claim 9, wherein the processor is further configured to:
receive a public key sent by the anti-theft hardware; and
establish and store the binding relationship between the public key and the TEE.

11. The apparatus according to claim 9, wherein the processor is further configured to perform at least one of:
disabling a service provided by the TEE or clearing current data, when the signature verification fails and it is determined that the physical peripheral is abnormal.

12. The apparatus according to claim 9, wherein the processor is further configured to perform at least one of:
disabling a service provided by the TEE or clearing current data, in response to a disabling request sent by the anti-theft hardware, wherein the disabling request is sent to the TEE when the anti-theft hardware determines that a physical invasion occurs on the physical peripheral.

13. The apparatus according to claim 9, wherein the processor is further configured to:
encrypt, based on the public key, data stored in the TEE.

14. A secure environment verification apparatus, wherein the apparatus is applied to anti-theft hardware, the anti-theft hardware is a part of a physical peripheral configured to protect a device, the device comprises a trusted execution environment (TEE), and the apparatus comprises:
a processor; and
a memory storing instructions executable by the processor,
wherein the processor is configured to perform the method according to claim 6.

15. A non-transitory computer-readable storage medium storing a computer program that, when executed by a processor, causes the processor to perform the method according to claim 1.

16. A non-transitory computer-readable storage medium storing a computer program that, when executed by a processor, causes the processor to perform the method according to claim 6.
